(19) United States
(12) Patent Application Publication
(10) Pub. No.: US 2026/0145922 A1
(43) Pub. Date: May 28, 2026

(54) JACK STAND SUPPORT VEHICLES

(71) Applicant: The Boeing Company, Arlington, VA (US)

(72) Inventors: Tyler J. Walker, Newtown Square, PA (US); Daniel John Williamson, Newtown Square, PA (US)

(21) Appl. No.: 18/957,326

(22) Filed: Nov. 22, 2024

(51) Int. Cl. B66F 13/00

(52) U.S. Cl. CPC B66F 13/00

(57) ABSTRACT

Jack stand support vehicles are disclosed. A disclosed apparatus for transporting a jack stand includes a base for supporting the jack stand, sidewalls extending from the base, the sidewalls supporting wheels by which the apparatus is moved, and a gate positioned on or proximate an opening defined by the sidewalls, the gate movable between (i) an open position for loading or unloading the jack stand and (ii) a closed position for retaining the jack stand.

### FIELD OF THE DISCLOSURE

This disclosure relates generally to vehicle production and service and, more particularly, to jack stand support vehicles.

### BACKGROUND

Aircraft jack stands are typically transported within a facility, such as a manufacturing facility or a service facility. In particular, the jack stands can be moved to different locations of a manufacturing facility to support and/or raise aircraft at multiple different areas (e.g., for service, for maintenance, etc.). However, aircraft jack stands can have significant weight and size and, as a result, can be difficult to move around.

### SUMMARY

An example apparatus for transporting a jack stand includes a base for supporting the jack stand, sidewalls extending from the base, the sidewalls supporting wheels by which the apparatus is moved, and a gate positioned on or proximate an opening defined by the sidewalls, the gate movable between (i) an open position for loading or unloading the jack stand and (ii) a closed position for retaining the jack stand.

An example cart for transporting a jack stand includes a ramped base having a surface to support the jack stand, first and second sidewalls extending from the base to first and second distal ends thereof, respectively, the first and second sidewalls supporting wheels for moving the cart, and first and second gates rotationally coupled to the first and second sidewalls, respectively, for retention of the jack stand.

An example method includes rotating a gate away from a base of a support vehicle for supporting a jack stand, the base having sidewalls extending therefrom, placing the jack stand on the base, rotating the gate toward the base, moving the support vehicle, rotating the gate away from the base, and removing the jack stand from the base.

### BRIEF DESCRIPTION OF THE DRAWINGS

FIG. 1 illustrates vehicle jack stands that can be transported by examples disclosed herein.

FIGS. 2A-2C illustrate an example jack stand support vehicle in accordance with teachings of this disclosure.

FIG. 3 illustrates a cab of the example jack stand vehicle.

FIG. 4 illustrates aspects of the example jack stand support vehicle of FIGS. 2A-3.

FIG. 5 is a flowchart representative of an example method to utilize examples disclosed herein.

FIG. 6 is a flowchart representative of an example method to produce examples disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Jack stand support vehicles are disclosed. Aircraft jack stands or jacks can have significant weight due to structural requirements necessitated to support an aircraft. Accordingly, the aircraft jack stands can be difficult to move/transport. Further, moving these jack stands can pose certain ergonomic challenges. For example, carts/movers for moving the jack stands typically utilize ramps that are heavy, relatively steep or necessitate a significant lifting height for an operator. Further, known carts/movers can necessitate lifting of the jack stands to a significant height, which can be challenging for an operator.

Examples disclosed herein utilize a support vehicle that can assist in movement and/or transportation of vehicle jack stands including, but not limited to, aircraft jack stands. Examples disclosed herein can advantageously facilitate placing of an aircraft jack stand on the support vehicle by having a relatively low placement height. Examples disclosed herein can also improve ergonomics of moving the aircraft jack stand onto the support vehicle by utilizing a ramp or inclined surface that is highly compact as a result of the relatively low height.

Examples disclosed herein include a wheeled support vehicle (e.g., a cart, a transport, a mover, etc.) with a cab having a base defining a support surface for carrying a jack stand. In turn, the cab includes sidewalls at first and second opposing lateral sides thereof. According to examples disclosed herein, the cab further includes at least one gate that is movably coupled (e.g., rotationally coupled, translatably coupled, etc.) to one of the sidewalls. In particular examples, a gate of the cab can be moved (e.g., rotated) to a first position (e.g., an open position) to enable the jack stand to be loaded/unloaded from the support vehicle and, conversely, the gate can be moved to a second position (e.g., a closed position) to at least partially restrain the jack stand during movement of the support vehicle. Accordingly, when the gate is moved (e.g., rotated) to an open position, the jack stand can be rolled on and off the support vehicle via a ramp that extends from the base or which is integral with the base. Conversely, when the gate is moved to a closed position, the jack stand is retained within the cart by the gate, thereby preventing the jack stand from falling out of the support vehicle as the support vehicle is moved.

In some examples, the sidewalls define an opening of the support vehicle and/or the cab such that first and second gates are positioned at opposite sides of the opening. Particularly, the first gate can be rotationally coupled to a first sidewall and, likewise, a second gate can be rotationally coupled to the second sidewall. In some examples, a wheel support/mount extends from a sidewall, and is positioned between the base and a distal end of the aforementioned sidewall to reduce an overall height between the base and the ground. In some examples, a chain or other restraint device is utilized to at least partially restrain the jack stand. In some examples, a sidewall include a tab defining an aperture to receive a portion of a forklift.

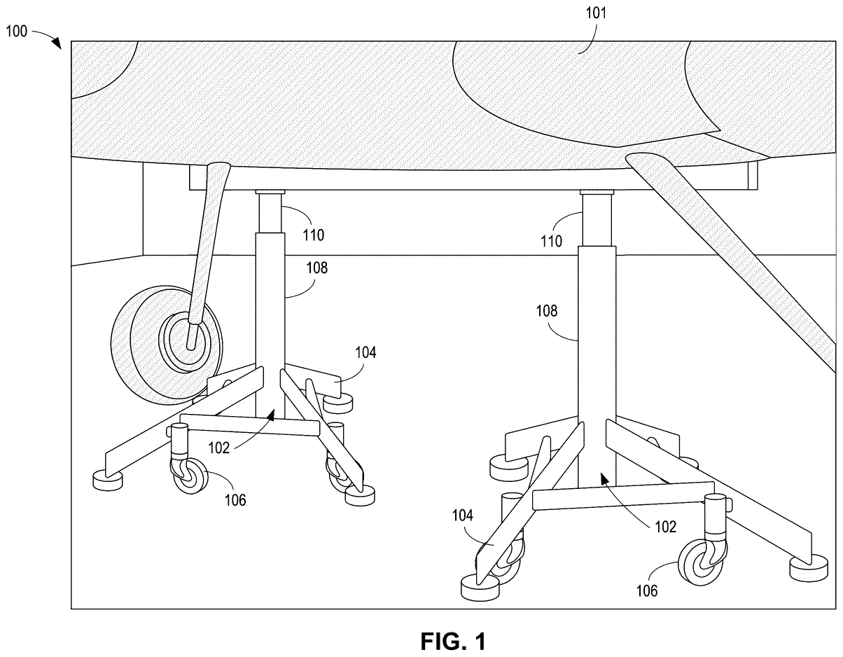

FIG. 1 illustrates an aircraft 101 with vehicle jack stands 102 that can be transported by examples disclosed herein. In the illustrated view of FIG. 1, the jack stands 102 are depicted supporting the weight of the aforementioned aircraft 101. In other words, the jack stands 102 are being utilized (e.g., for aircraft production, for aircraft service, etc.). When the jack stands 102 are not being utilized to support aircraft, the jack stands 102 can be moved for later use or storage.

The jack stands 102 each include support walls 104, wheels (e.g., caster wheels, wheel assemblies, etc.) 106, a support 108 and an interface 110. The wheels 106 enable the jack stands 102 to be moved (e.g., to other aircraft, to an area, etc.). However, due to the significant weight, the height and general shape of the jack stands 102, it can be cumbersome to move the jack stands 102, especially across significant distances. Accordingly, examples disclosed herein can improve ease of handling, transport and ergonomics associated with the jack stands 102.

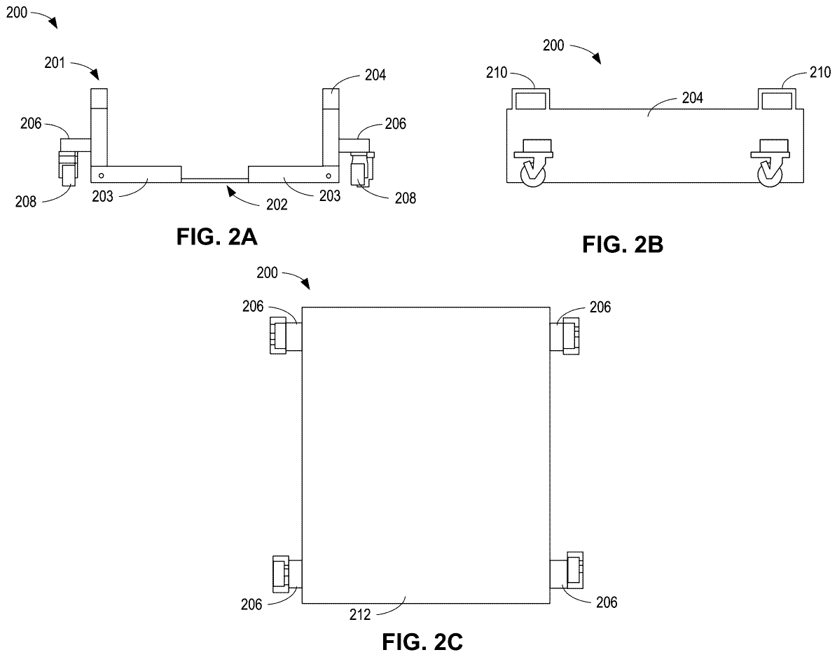

FIGS. 2A-2C illustrate an example jack stand support vehicle 200 in accordance with teachings of this disclosure. Turning to FIG. 2A, a front view of the jack stand support vehicle 200 is shown. In the illustrated example of FIG. 2A, the support vehicle 200 includes a cab (e.g., a chassis, a storage portion, a carriage, etc.) 201. In turn, the example cab 201 includes a base 202, gates (e.g., movable gates, rotatable gates, translatable gates, etc.) 203, sidewalls (e.g., opposing sidewalls, opposedly facing sidewalls, etc.) 204 extending from the base 202, and wheel supports (e.g., wheel mounts, wheel support protrusions, wheel tabs, etc.) 206 that support and/or position wheels 208. According to some examples disclosed herein, a distal end of the gate 203 extends approximately 9 inches (in) to 15 in (e.g., 12 in) from the corresponding sidewall 204. Further, in some examples, the wheel supports 206 extend approximately 4 in to 6 in (e.g., 5 in) from the corresponding sidewall 204.

FIG. 2B depicts a side view of the example support vehicle 200. In the illustrated view of FIG. 2B, the sidewall 204 supports, positions and/or defines forklift tabs 210 that are positioned at a distal end of the corresponding sidewall 204. The example forklift tabs 210 each define a protrusion/tab with an aperture extending therethrough to receive at least a portion of a forklift. According to examples disclosed herein, the forklift tabs 210 are placed at opposing ones of the sidewalls 204, thereby enabling a forklift to lift and/or carry the support vehicle 200 by supporting both of the sidewalls 204. In some examples, heights of the sidewalls 204 are approximately 9 in to 15 in (e.g., 12 in).

Turning to FIG. 2C, a bottom view of the example support vehicle 200 is shown. As can be seen in the illustrated example of FIG. 2C, the wheel supports 206 are spaced apart along a longitudinal direction (up and down in the view of FIG. 2C) and a lateral direction (left and right in the view of FIG. 2C). According to examples disclosed herein, a bottom surface 212 of the example support vehicle 200 is relatively flat to reduce clearance to the ground/surface that supports the support vehicle 200, thereby enabling the support vehicle 100 to be at a relatively low height to increase ergonomic functionality thereof. In other words, the bottom surface 212 can be positioned relatively close to the ground (e.g., at a minimal clearance to the ground) to reduce a lifting height needed to place the jack stand onto the support vehicle 200.

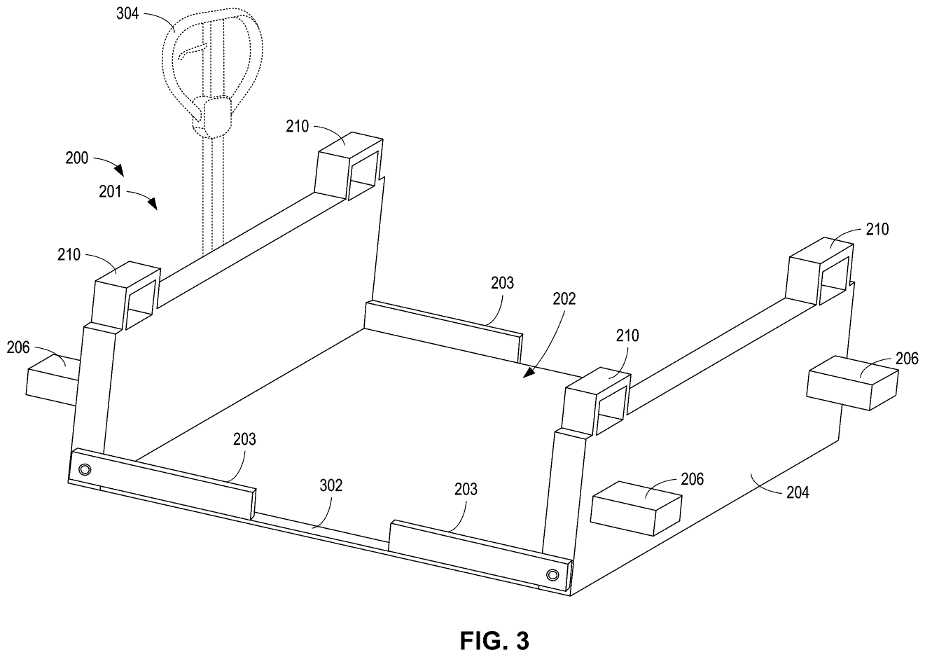

FIG. 3 illustrates the cab 201 of the example support vehicle 200. In the illustrated example of FIG. 3, the base 202 of the cab 201 is shown supporting the opposing sidewalls 204 which, in turn, mount the wheel supports 206 and the forklift tabs 210. In this example, the sidewalls 204 define openings therebetween that can be at least partially covered by the gates 203, which are arranged as pairs on lateral sides of the support vehicle 200. Accordingly, the openings can be utilized for moving a jack stand onto the support vehicle 200. In this example, each of the wheel supports 206 is placed at an intermediate height of the corresponding sidewall 204 to significantly lower the base 202 with respect to the ground and, as a result, the jack stand can be easily loaded onto the base 202 via the ramp 302. In some examples, the ramp 302 is movable and/or rotatable from the base 202.

To facilitate moving the jack stand onto the support vehicle 200, the support vehicle 200 includes a ramp 302. In particular, because the base 202 is relatively low to the ground, the ramp 302 is also relatively low to the ground, thereby enabling the jack stand to be moved and/or rolled onto the support vehicle with relative ease. The example ramp 302 may be implemented as a contour on a carrying surface of the base 202. In some examples, the ramp 302 extends across an entire span of the base 202 between the two sidewalls 204. In some examples, the ramp 302 is a bent surface or portion of the base 202. According to some examples disclosed herein, a handle 304 is implemented to facilitate transport of the support vehicle 200. In some such examples, the handle 304 can control a brake of the support vehicle 200, for example.

In some examples, the base 202 and/or the cab 201 includes and/or is at least partially composed of a metal, such as aluminum or steel. However, any other material type or material can be implemented instead.

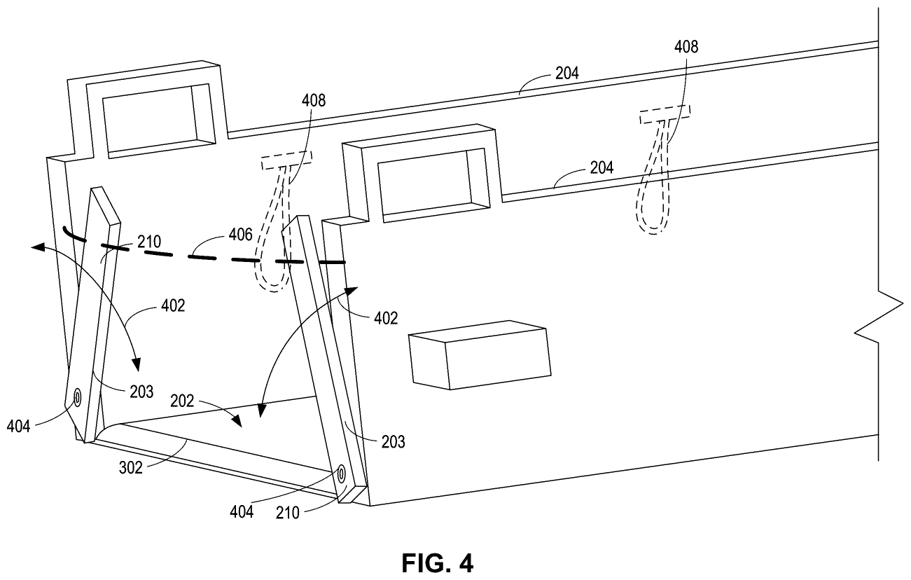

FIG. 4 illustrates aspects of the example jack stand support vehicle 200 of FIGS. 2A-3. In the illustrated example of FIG. 4, the example jack stand support vehicle 200 is shown in a loading/unloading state based on a displacement of the gates 203. In particular, both of the gates 203 are depicted rotated upward (in the view of FIG. 4) to enable removal or placement/loading of the jack stand with respect to the support vehicle 200. Further, the ramp 302, which may be extendible/rotatable relative to the base 202, is utilized for removal or placement of the jack stand onto the base 202. As a result, the jack stand can be loaded onto/unloaded from the base 202 with relative ease. In some examples, both longitudinal ends of the support vehicle 200 include a corresponding ramp (as well as a corresponding opening between the sidewalls 204).

To enable rotation of the gates 203, the example gates 203 are rotatably coupled to respective ones of the sidewalls 204 and can pivot relative to the sidewalls 204, as generally indicated by double arrows 402. In this example, the sidewalls 204 each include and/or define pivots (e.g., rotational joints, pivoting joints, etc.) 404 that define rotational axes of the gates 203. According to some examples disclosed herein, axes of rotations of the gates 203 on the same sidewall 204 are generally aligned (e.g., are co-linear). Additionally or alternatively, the gates 203 are translatably coupled to the base 202. In this example, the gates 203 are movable between a closed position for transporting the jack stand, and an open position for loading/unloading the jack stand.

In some examples, the gates 203 are biased. In particular, the gates 203 may be biased and/or urged to a closed position via a spring or other urging device. In some examples, a tether (e.g., a chain, a rope, a line, etc.) 406 spans between the sidewalls 204 to constrain the jack stand as the support vehicle 200 is moved, thereby preventing the jack stand from rolling or falling out of the support vehicle 200. According to some examples disclosed herein, at least one tether (e.g., at least one safety wire, a retention loop, etc.) 408 is implemented to retain the hack stand. In some such examples, the tether(s) 408 can be coiled around at least a portion of the jack stand to constrain the same during movement of the support vehicle 200. According to some examples disclosed herein, each of the sidewalls 204 has two of the tethers 408 mounted thereto. However, any other appropriate number of the tethers 408 can be implemented instead. In some examples, the gates 203 on the same one of the sidewalls 204 have rotational axes that are generally aligned to one another (e.g., the gates 203 on opposing longitudinal ends of the support vehicle 200).

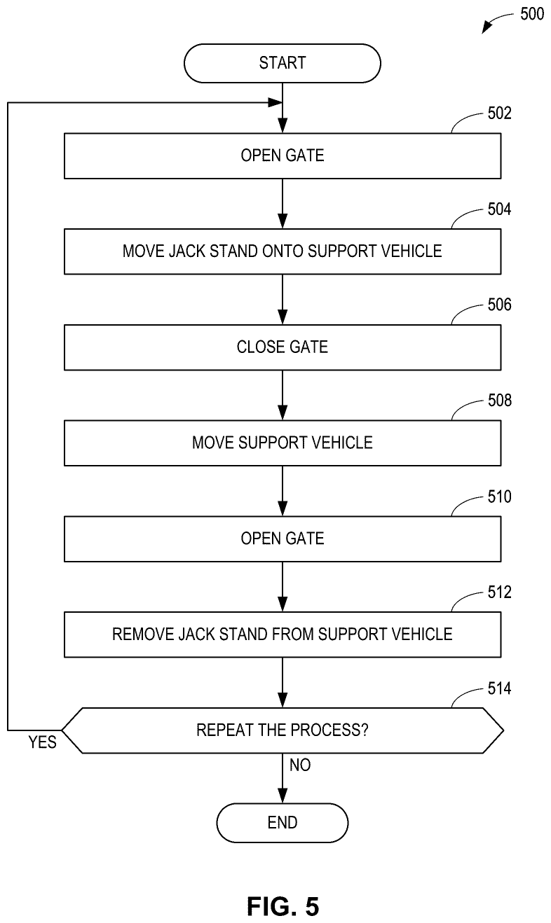

FIG. 5 is a flowchart representative of an example method 500 to implement examples disclosed herein. At block 502, at least one gate (e.g., the gate 203) is opened. In this example, the gate(s) is rotated to provide clearance to an opening defined by sidewalls (e.g., the sidewalls 204) of the support vehicle.

At block 504, a jack stand is moved and/or rolled onto a base of the support vehicle via the opening defined by the sidewalls (e.g., a space between the sidewalls). In some examples, the jack stand is lifted and/or tilted to a relatively small degree to reach a ramp of the base. In some examples, the ramp is extended outward or rotated for use with the jack stand.

At block 506, the aforementioned gate is closed and/or moved to a closed position for retention of the jack stand. In some examples, the gate is locked and/or releasably coupled to a sidewall. Additionally or alternatively, the gate is spring-loaded into the closed position, for example.

At block 508, the support vehicle is moved. In this example, the support vehicle is moved and/or rolled to a position at which the jack stand is to be deployed (e.g., to an aircraft).

At block 510, the gate is opened and/or moved to an open position.

At block 512, the jack stand is removed from the support vehicle. In this example, the jack stand is moved down the aforementioned ramp of the base. In some examples, the ramp is extended out or rotated from the base.

At block 514, it is determined whether to repeat the process. If the process is to be repeated (block 514), control of the process returns to block 502. Otherwise, the process ends.

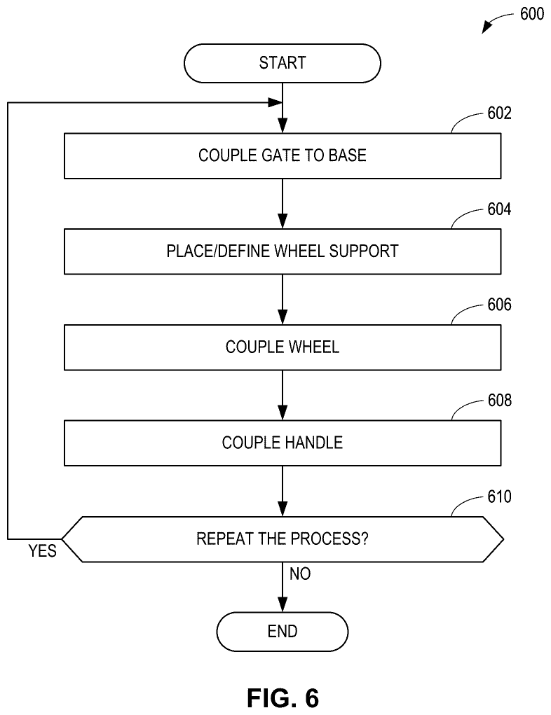

FIG. 6 is a flowchart representative of an example method 600 to produce examples disclosed herein. In particular, the example method 600 is implemented to produce a support vehicle for transporting jack stands.

At block 602, a gate is coupled to a base and/or a cab. In this example, the gate is rotationally coupled to the base and/or the cab. Additionally or alternatively, the gate is translatably coupled to the base and/or the cab.

At block 604, a wheel support/mount is defined or placed onto a corresponding side wall extending from the base.

At block 606, a wheel (e.g., a caster, a wheel assembly, etc.) is coupled to the wheel support/mount. In this example, the wheel support/mount is positioned between the base and a distal end of the aforementioned side wall extending from the base.

At block 608, a handle is coupled to the base and/or the cab. Additionally or alternatively, a tether (e.g., a chain, a rope, etc.) is coupled to the base and/or the cab to enable further restraint of the jack stand.

At block 610, it is determined whether to repeat the process. If the process is to be repeated (block 610), control of the process returns to block 602. Otherwise, the process ends. The determination may be based on whether additional support vehicles/carts are to be produced.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example methods, apparatus, systems, and articles of manufacture to facilitate movement and improve ergonomics for transporting jack stands are disclosed herein. Further examples and combinations thereof include the following:
Example 1 includes an apparatus for transporting a jack stand, the apparatus comprising a base for supporting the jack stand, sidewalls extending from the base, the sidewalls supporting wheels by which the apparatus is moved, and a gate positioned on or proximate an opening defined by the sidewalls, the gate movable between (i) an open position for loading or unloading the jack stand and (ii) a closed position for retaining the jack stand.
Example 2 includes the apparatus as defined in example 1, further including a ramp proximate or on the base.
Example 3 includes the apparatus as defined in example 2, wherein the ramp is at least one of extendible or foldable with respect to the base.
Example 4 includes the apparatus as defined in any of examples 1 to 3, further including a mount extending from at least one of the sidewalls, the mount to support at least one of the wheels.
Example 5 includes the apparatus as defined in example 4, wherein the mount is positioned between the base and a distal end of the sidewall.
Example 6 includes the apparatus as defined in any of examples 1 to 5, wherein two of the sidewalls each include a protrusion including an aperture to receive a portion of a lifting device.
Example 7 includes the apparatus as defined in any of examples 1 to 6, wherein the gate is to rotate about a pivot positioned on a respective one of the sidewalls.
Example 8 includes the apparatus as defined in example 7, wherein the gate is a first gate rotatably coupled to a first sidewall of the sidewalls, and further including a second gate rotatably coupled to a second sidewall of the sidewalls, the second sidewall opposedly facing the first sidewall.
Example 9 includes a cart for transporting a jack stand, the cart comprising a ramped base having a surface to support the jack stand, first and second sidewalls extending from the base to first and second distal ends thereof, respectively, the first and second sidewalls supporting wheels for moving the cart, and first and second gates rotationally coupled to the first and second sidewalls, respectively, for retention of the jack stand.
Example 10 includes the cart as defined in example 9, wherein first and second pivots of the first and second gates, respectively, are positioned on the first and second sidewalls, respectively.
Example 11 includes the cart as defined in any of examples 9 or 10, further including first and second wheel mounts laterally extending from the first and second sidewalls, respectively, the first and second wheel mounts to support the wheels.
Example 12 includes the cart as defined in example 11, wherein the first and second wheel mounts are positioned between the base and first and second distal ends of the first and second sidewalls, respectively.
Example 13 includes the cart as defined in any of examples 9 to 12, wherein the first and second sidewalls each include tabs having apertures extending therethrough to receive at least a portion of a forklift.
Example 14 includes the cart as defined in example 13 wherein the tabs extend past distal ends of the first and second sidewalls.
Example 15 includes the cart as defined in any of examples 9 to 14, further including third and fourth gates, the third and fourth gates rotationally coupled to the first and second sidewalls respectively.
Example 16 includes the cart as defined in example 15, wherein a first axis of rotation of the first gate is aligned with a second axis of rotation of the second gate, and wherein a third axis of rotation of the second gate is aligned with a fourth axis of rotation of the fourth gate.
Example 17 includes the cart as defined in any of examples 9 to 16, further including a chain or a tether to be placed between the first and second sidewalls.
Example 18 includes the cart as defined in any of examples 9 to 17, wherein a ramp of the base is extendible from the base.
Example 19 includes a method comprising rotating a gate away from a base of a support vehicle for supporting a jack stand, the base having sidewalls extending therefrom, placing the jack stand on the base, rotating the gate toward the base, moving the support vehicle, rotating the gate away from the base, and removing the jack stand from the base.
Example 20 includes the method as defined in example 19, further including extending or rotating a ramp from the base.

From the foregoing, it will be appreciated that example systems, apparatus, articles of manufacture, and methods have been disclosed that enable transportation and handling of vehicle jack stands (e.g., aircraft jack stands, automotive jack stands, etc.). Examples disclosed herein can also enable improve ergonomics with respect to the vehicle jack stands.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus for transporting a jack stand, the apparatus comprising:
a base for supporting the jack stand;
sidewalls extending from the base, the sidewalls supporting wheels by which the apparatus is moved; and
a gate positioned on or proximate an opening defined by the sidewalls, the gate movable between (i) an open position for loading or unloading the jack stand and (ii) a closed position for retaining the jack stand.

2. The apparatus as defined in claim 1, further including a ramp proximate or on the base.

3. The apparatus as defined in claim 2, wherein the ramp is at least one of extendible or foldable with respect to the base.

4. The apparatus as defined in claim 1, further including a mount extending from at least one of the sidewalls, the mount to support at least one of the wheels.

5. The apparatus as defined in claim 4, wherein the mount is positioned between the base and a distal end of the sidewall.

6. The apparatus as defined in claim 1, wherein two of the sidewalls each include a protrusion including an aperture to receive a portion of a lifting device.

7. The apparatus as defined in claim 1, wherein the gate is to rotate about a pivot positioned on a respective one of the sidewalls.

8. The apparatus as defined in claim 7, wherein the gate is a first gate rotatably coupled to a first sidewall of the sidewalls, and further including a second gate rotatably coupled to a second sidewall of the sidewalls, the second sidewall opposedly facing the first sidewall.

9. A cart for transporting a jack stand, the cart comprising:
a ramped base having a surface to support the jack stand;
first and second sidewalls extending from the base to first and second distal ends thereof, respectively, the first and second sidewalls supporting wheels for moving the cart; and
first and second gates rotationally coupled to the first and second sidewalls, respectively, for retention of the jack stand.

10. The cart as defined in claim 9, wherein first and second pivots of the first and second gates, respectively, are positioned on the first and second sidewalls, respectively.

11. The cart as defined in claim 9, further including first and second wheel mounts laterally extending from the first and second sidewalls, respectively, the first and second wheel mounts to support the wheels.

12. The cart as defined in claim 11, wherein the first and second wheel mounts are positioned between the base and first and second distal ends of the first and second sidewalls, respectively.

13. The cart as defined in claim 9, wherein the first and second sidewalls each include tabs having apertures extending therethrough to receive at least a portion of a forklift.

14. The cart as defined in claim 13 wherein the tabs extend past distal ends of the first and second sidewalls.

15. The cart as defined in claim 9, further including third and fourth gates, the third and fourth gates rotationally coupled to the first and second sidewalls respectively.

16. The cart as defined in claim 15, wherein a first axis of rotation of the first gate is aligned with a second axis of rotation of the second gate, and wherein a third axis of rotation of the second gate is aligned with a fourth axis of rotation of the fourth gate.

17. The cart as defined in claim 9, further including a chain or a tether to be placed between the first and second sidewalls.

18. The cart as defined in claim 9, wherein a ramp of the base is extendible from the base.

19. A method comprising:
rotating a gate away from a base of a support vehicle for supporting a jack stand, the base having sidewalls extending therefrom;
placing the jack stand on the base;
rotating the gate toward the base;
moving the support vehicle;
rotating the gate away from the base; and
removing the jack stand from the base.

20. The method as defined in claim 19, further including extending or rotating a ramp from the base.
